(19) United States
(12) Patent Application Publication
(10) Pub. No.: US 2009/0047085 A1
(43) Pub. Date: Feb. 19, 2009

(54) Multiple spur multiple spiral groove twist drill

(76) Inventors: Chung Liang Liao, Taichung County (TW); Chung-Hung Liao, Taichung County (TW)

Correspondence Address: BIRCH STEWART KOLASCH & BIRCH, PO BOX 747, FALLS CHURCH, VA, 22040-0747, US

(21) Appl. No.: 11/889,408

(22) Filed: Aug. 13, 2007

(51) Int. Cl. B23B 51/02

(52) U.S. Cl. 408/230

(57) ABSTRACT

A MULTIPLE SPUR MULTIPLE SPIRAL GROOVE TWIST DRILL includes a flute, whose shank is clamped and secured to a tooling holder of a drilling machine and contains multiple spiral flute grooves; each flute groove is disposed on its peripheral a flute land, a cutting section is formed on a front tip of the flute land; a spur formed at where the cutting section and the flute land crossing each other; and a lead screw point with tapered thread being disposed at a center on the front of the flute to increase strength of the cutting section; and the flute groove in conjunction with the flute to fortify the overall structural strength to provide longer service life and cost benefits of the drill.

### FIELD OF THE INVENTION

The present invention is related to a MULTIPLE SPUR MULTIPLE SPIRAL GROOVE TWIST DRILL, and more particularly, to an improved construction of a spade bit that provides prolonged service life and cost efficiency.

### BACKGROUND OF THE INVENTION

Whereas wooden materials usually have to undergo scraping, planning, sawing, cutting, and/or drilling processes for assembly before becoming a finished product as designed; as illustrated in FIG. 5 of the accompanying drawings for a perspective view of a front of a spade bit (3) of the prior art, it is comprised of a spade portion (31) and a lead TIP(32); a corner tip (311) is disposed on the peripheral of both sides at the front of the spade portion (31); to start the process, a comparatively small hole is drilled on a designated wooden work piece to lead smooth guiding for initial cutting. Once the spade bit enters into a surface layer of the work piece, followed with further cutting using the both corner tips (311), and finally the substantial part of cutting task is done with the spade portion (31) to achieve cutting and drilling functions by the spade bit (3).

However, each tip disposed on the edge on both sides of the front of the spade portion of the prior art indicates a tapered end surface, and designed as a flat and thin tip by compromising the spade portion, leading to poor strength of the overall structure of the drill. The tip could easily get broken and damaged when contacting any hard matter hidden in the wooden work piece, leading to affected the schedule of drilling task, limited operation efficacy, and the waste of operation cost.

### SUMMARY OF THE INVENTION

The primary purpose of the present invention is to provide a MULTIPLE SPUR MULTIPLE SPIRAL GROOVE TWIST DRILL comprised of a flute and an inwardly formed spiral; and a spur is formed at where the flute and a cutting section crossing each other for the drill to be of industrial utility and cost benefits.

To achieve the purpose, a MULTIPLE SPUR MULTIPLE SPIRAL GROOVE TWIST DRILL of the present invention is comprised of a flute, whose shank is clamped and secured to a tooling holder of a drilling machine; containing multiple spiral, and four is preferred, flute grooves; a flute disposed on a peripheral of the flute groove; a cutting section is formed on a front of the flute; a spur is formed at where the cutting section and the flute crossing each other; and a lead screw tapered and threaded is disposed at a center on the front of the flute.

In practice, increased strength for the cutting section by the spur in conjunction with the flute groove and the flute land upgrades the overall structural strength of the drill.

### BRIEF DESCRIPTION OF THE DRAWINGS

FIG. 1 is a perspective view of the present invention.

FIG. 2 is a front view of the present invention.

FIG. 3 is a bird's view of the present invention.

FIG. 4 is a schematic view showing a preferred embodiment of the present invention.

FIG. 5 is a perspective view showing a spade bit of the prior art for woodworking.

### DETAILED DESCRIPTION OF THE PREFERRED EMBODIMENTS

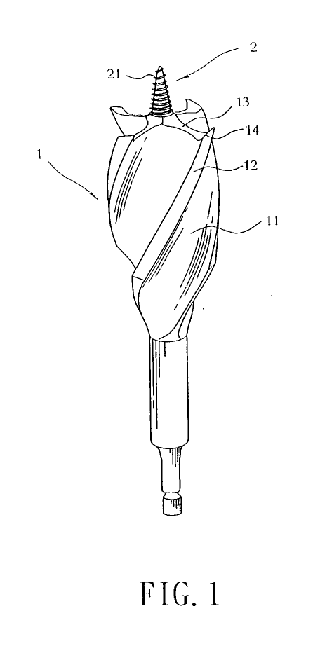

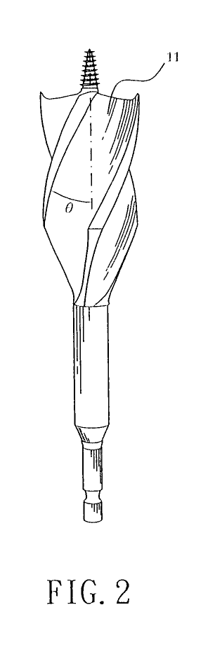

Referring to FIGS. 1 and 2, a MULTIPLE SPUR MULTIPLE SPIRAL GROOVE TWIST DRILL of the present invention is comprised of a flute (1), whose shank is clamped and secured to a tooling holder of a drilling machine, containing multiple, and four is preferred, spiral flute grooves (11); a cutting section (13) is provided to a front of the flute land (12); a spur (14) is disposed is formed at where the cutting section (13) and the flute (12) crossing each other; and a lead screw point (2) disposed at a center on a front of the flute (1) is provided with a tapered thread (21) to provide the MULTIPLE SPUR MULTIPLE SPIRAL GROOVE TWIST DRILL for drilling a wooden work piece.

The spiral flute groove (11) is designed with a spiral angle θ that is reduced to 30° for increasing drilling power in feeding the drill.

The flute land (12) is itself formed inwardly as flute grooves (11) to provide support and upgrade cutting torque for the flute land (12).

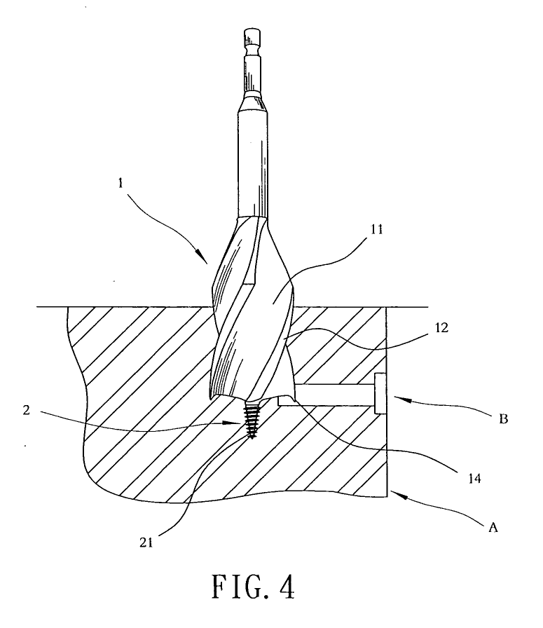

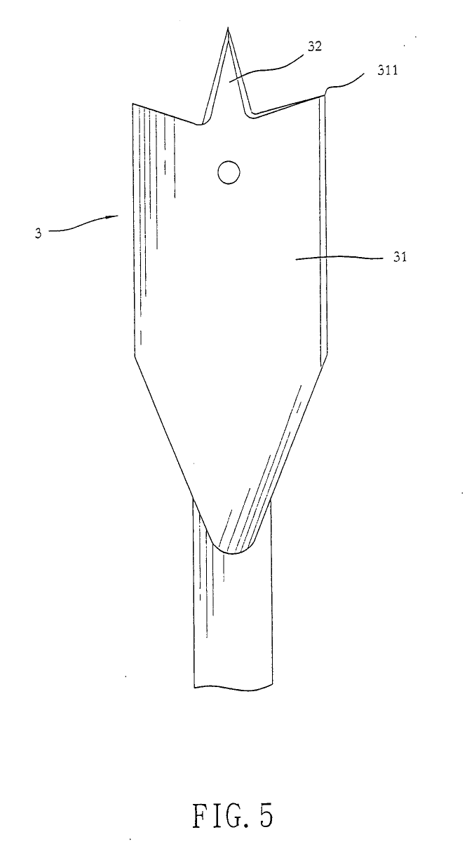

The sharp spur (14) disposed at where the cutting section (13) and the flute land (12) crossing each other causes the cutting section (13) to get thicken and thus to fortify the cutting section (13) to correct the problem of braking and damaging a sharp section of a corner tip (311) form a spade bit (3) of the prior art as illustrated in FIG. 5 upon contacting a hard matter (B) as illustrated in FIG. 4 in the drilling process.

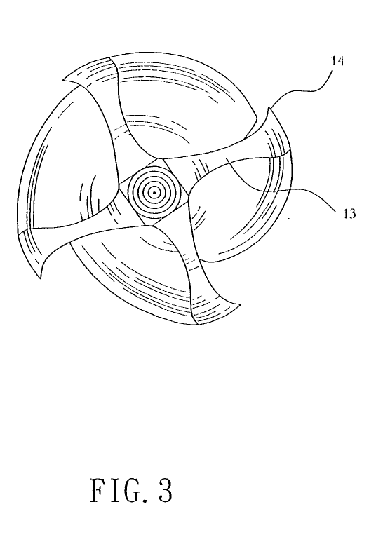

Now referring to FIG. 3, the spur (14) is one of those approaches taken by the present invention to fortify the structure of the drill for providing sufficient increase of strength of the cutting section (13) to handle a drilling task under severe conditions.

As illustrated in FIG. 4, the flute (1) of the present invention has the lead screw point (2) provided with tapered threads (21) inserted and held in position onto the wooden work piece (A) to perform drilling to further guide the flute land (12) to carry out a primary cutting and drilling task. Whereas the residual matter (B) that is comparatively harder from a previous process may be found in the wooden work piece (A), the overall structural strength of the drill is enhanced through design of the sharp spur (14) and the spiral flute groove (11) in conjunction with the flute land (12). Accordingly, when the lead screw point (2) and the flute land (12) contact the hard matter (B), they are able to forthwith penetrate through the harder matter (B) without causing damage to the structure of the drill.

As illustrated in FIGS. 1 through 4, the spur (14) formed at where the cutting section (13) and the flute land (12) crossing each other, and the flute groove (11) formed inwardly by the flute land (12) fortify the structure of the drill to prevent it from being broken and damaged upon contacting the harder matter (B) hidden in a used wooden work piece. Therefore, the present invention helps significantly reduce consumption costs of the drill for the present invention to provide its industrial utility and economic benefits.

When compared to a spade bit of the prior art, the present invention fortifies strength of the cutting section by forming a sharp spur at where the cutting section and the flute land crossing each other and further fortifies the overall strength of the drill by providing the flute groove and the flute land to forthwith cut through hard matter hidden in the wooden work piece for achieving longer service life for the drill. The present invention does provide industrial utility and cost benefits while its overall structure has never been disclosed in any publication or use in public. The application for a utility patent is duly filed accordingly.

However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A MULTIPLE SPUR MULTIPLE SPIRAL GROOVE TWIST DRILL comprising:
a flute, whose shank is clamped and secured to a tooling holder of a drilling machine; containing multiple, four is preferred, flute grooves, a flute land being disposed on a peripheral of the flute groove, a cutting section formed at a front of the flute, and a spur being formed at where the cutting section and the flute land crossing each other; and
a lead screw point located at a center on the front of the flute, and provided with tapered threads.

2. The MULTIPLE SPUR MULTIPLE SPIRAL GROOVE TWIST DRILL as claimed in claim 1, wherein a spiral angle θ of the flute groove is reduced to 30° to increase drilling strength.
